(19) United States
(12) Patent Application Publication
(10) Pub. No.: US 2026/0149161 A1
(43) Pub. Date: May 28, 2026

(54) POWER-COMBINING DEVICES WITH MULTIPLE SPATIAL POWER-COMBINERS AND RELATED SYSTEMS AND METHODS

(71) Applicant: Qorvo US, Inc., Greensboro, NC (US)

(72) Inventor: Soack Dae Yoon, Torrance, CA (US)

(21) Appl. No.: 19/337,407

(22) Filed: Sep. 23, 2025

Related U.S. Application Data
(60) Provisional application No. 63/724,998, filed on Nov. 26, 2024.

(51) Int. Cl. H01P 5/19; H01P 3/12; H01P 11/00

(52) U.S. Cl. CPC H01P 5/19; H01P 3/12; H01P 11/00

(57) ABSTRACT

Power-combining devices and, more particularly, power-combining devices with multiple spatial power-combining devices for increased output power and related systems and methods are disclosed. Power-combining devices with multiple spatial power-combining devices provide multiple levels of signal splitting for amplification, followed by multiple levels of signal combining to provide an output signal with increased output power. Exemplary power-combining devices are capable of providing output powers in the kilowatt range. Spatial power-combining devices may be radially arranged about a support structure of the overall power-combining device to provide multiple levels of radially splitting and multiple levels of radial combining.

### RELATED APPLICATIONS

This application claims the benefit of U.S. provisional patent application serial number 63/724,998, filed November 26, 2024, the disclosure of which is incorporated herein by reference in its entirety.

### FIELD OF THE DISCLOSURE

The disclosure relates generally to power-combining devices and, more particularly, to power-combining devices with multiple spatial power-combining devices for increased output power and related systems and methods.

### BACKGROUND

Solid state power amplifiers (SSPAs) are used for broadband radio frequency power amplification in commercial and defense communications, radar, electronic warfare, satellite, and various other communication systems. As modern SSPA applications continue to advance, increasingly higher and higher saturated output power is desired. While millimeter wave (mmWave) gallium nitride (GaN) monolithic microwave integrated circuits (MMICs) have made great strides for use in SSPAs, there are many applications where even higher power densities may be out of reach for a single device. Spatial power-combining devices have been developed that provide a means to combine the output of several separate MMICs to realize a SSPA with much larger output power than that of a single device. Spatial power-combining techniques are implemented by combining broadband signals from a number of amplifiers to provide output powers with high efficiencies and operating frequencies.

One example of a spatial power-combining device utilizes a plurality of solid-state amplifier assemblies that forms a coaxial waveguide to amplify an electromagnetic signal. Each amplifier assembly may include an input antenna structure, an amplifier, and an output antenna structure. When the amplifier assemblies are combined to form the coaxial waveguide, the input antenna structures may form an input antipodal antenna array, and the output antenna structures may form an output antipodal antenna array. In operation, an electromagnetic signal is passed through an input port to an input coaxial waveguide section of the spatial power-combining device. The input coaxial waveguide section distributes the electromagnetic signal to be split across the input antipodal antenna array. The amplifiers receive the split signals and in turn transmit amplified split signals across the output antipodal antenna array. The output antipodal antenna array and an output coaxial waveguide section combine the amplified split signals to form an amplified electromagnetic signal that is passed to an output port of the spatial power-combining device.

Antenna structures for spatial power-combining devices typically include an antenna signal conductor and an antenna ground conductor deposited on opposite sides of a substrate, such as a printed circuit board. The size of the antenna structures is related to an operating frequency of the spatial power-combining device. For example, the size of the input antenna structure is related to the frequency of energy that can be efficiently received, and the size of the output antenna structure is related to the frequency of energy that can be efficiently transmitted. Overall sizes of spatial power-combining devices typically scale larger or smaller depending on desired operating frequency ranges.

The art continues to seek improved spatial power-combining devices having improved performance characteristics while being capable of overcoming challenges associated with conventional devices.

### SUMMARY

The disclosure relates generally to power-combining devices and, more particularly, to power-combining devices with multiple spatial power-combining devices for increased output power and related systems and methods. Power-combining devices with multiple spatial power-combining devices provide multiple levels of signal splitting for amplification, followed by multiple levels of signal combining to provide an output signal with increased output power. Exemplary power-combining devices are capable of providing output powers in the kilowatt range. Spatial power-combining devices may be radially arranged about a support structure of the overall power-combining device to provide multiple levels of radially splitting and multiple levels of radial combining.

In one aspect, a power-combining device comprises: an input waveguide configured to split an input signal; a plurality of spatial power-combining devices coupled with the input waveguide, each spatial power-combining device of the plurality of spatial power-combining devices configured to receive a split portion of the input signal; and an output waveguide configured to combine amplified signals from the plurality of spatial power-combining devices into an output signal. The power-combining device may further comprise a support structure, wherein the plurality of spatial power-combining devices are mounted to the support structure. In certain embodiments, a first spatial power-combining device of the plurality of spatial power-combining devices is mounted to a first face of the support structure, and a second spatial power-combining device of the plurality of spatial power-combining devices is mounted to a second face of the support structure, and the second face is different than the first face. In certain embodiments, each individual spatial power-combining device of the plurality of spatial power-combining devices is mounted on a different face of the support structure. In certain embodiments, the support structure forms a common heat sink for the plurality of spatial power-combining devices. The power-combining device may further comprise a plurality of individual heat sinks coupled to the common heat sink, wherein each individual heat sink of the plurality of individual heat sinks is arranged to at least partially enclose a portion of a separate spatial power-combining device of the plurality of spatial power-combining devices. In certain embodiments, the input waveguide and the output waveguide each comprise at least two mode converters for transitioning between multiple waveguide modes. In certain embodiments, the input waveguide and the output waveguide each comprise a plurality of waveguide channels connected to a common waveguide channel at one of the at least two mode converters. In certain embodiments, the plurality of waveguide channels comprises rectangular waveguide channels and the common waveguide channel comprises a cylindrical waveguide channel. The power-combining device may further comprise at least one phase shifter positioned between the input waveguide and the plurality of spatial power-combining devices. In certain embodiments, the at least one phase shifter comprises a plurality of phase shifters, and each phase shifter of the plurality of phase shifters is configured to be independently adjustable. In certain embodiments, the at least one phase shifter comprises a plurality of phase shifters, and each phase shifter of the plurality of phase shifters is configured to be controlled for common control.

In another aspect, a system for transmitting radio frequency energy comprises: at least one power-combining device, wherein the at least one power-combining device comprises: an input waveguide configured to split an input signal; a plurality of spatial power-combining devices coupled with the input waveguide, each spatial power-combining device of the plurality of spatial power-combining devices configured to receive a split portion of the input signal; and an output waveguide configured to combine amplified signals from the plurality of spatial power-combining devices into an output signal. In certain embodiments, the at least one power-combining device comprises a support structure, and the plurality of spatial power-combining devices are mounted to the support structure. In certain embodiments, the input waveguide and the output waveguide each comprise a plurality of waveguide channels connected to a common waveguide channel at one of at least two mode converters. In certain embodiments, the at least one power-combining device comprises a plurality of power-combining devices. In certain embodiments, the system comprises a driver module connected to the plurality of power-combining devices and an output module configured to receive the output signal.

In another aspect, a method of forming a power-combining device comprises: radially arranging a plurality of spatial power-combining devices about a support structure; coupling an input waveguide to the plurality of spatial power-combining devices, the input waveguide configured to split an input signal; and coupling an output waveguide to the plurality of spatial power-combining devices, the output waveguide configured to combine amplified signals from the plurality of spatial power-combining devices into an output signal. The method may further comprise thermally coupling a plurality of individual heat sinks to the support structure, wherein each individual heat sink of the plurality of individual heat sinks is arranged to at least partially enclose a portion of a separate spatial power-combining device of the plurality of spatial power-combining devices. In certain embodiments, the input waveguide is configured to split the input signal into at least two split signals, and each spatial power-combining device is configured to further split each split signal at least eight times for amplification.

In another aspect, any of the foregoing aspects individually or together, and/or various separate aspects and features as described herein, may be combined for additional advantage. Any of the various features and elements as disclosed herein may be combined with one or more other disclosed features and elements unless indicated to the contrary herein.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1A is a partially-exploded perspective view of an exemplary spatial power-combining device according to principles of the present disclosure.

FIG. 1B is a perspective view of an individual amplifier assembly of the spatial power-combining device of FIG. 1A.

FIG. 2A is a perspective view of a power-combining device with four spatial power-combining devices arranged to receive split portions of an input signal for amplification according to principles of the present disclosure.

FIG. 2B is a perspective view of the output waveguide of FIG. 2A.

FIG. 2C is a side view of the power-combining device of FIG. 2A.

FIG. 2D is an end view of the power-combining device of FIG. 2A from the perspective of the output waveguide.

FIG. 2E is an opposing end view of the power-combining device of FIG. 2A from the perspective of the input waveguide.

FIG. 3 is a perspective view of a power-combining device that is similar to the power-combining device of FIGS. 2A to 2E for embodiments that further include one or more phase shifters.

FIG. 4A is a plot representing output power versus frequency for each individual spatial power-combining device of FIG. 2A.

FIG. 4B is an S-parameters plot representing simulated performance of the input or output waveguides of FIGS. 2A to 2E for four-way splitting or combining.

FIG. 4C is an S-parameters plot representing simulated responses of the overall power-combining device of FIGS. 2A to 2E.

FIG. 4D represents simulated radio frequency (RF) power sweeps for the overall power-combining device of FIGS. 2A to 2E.

FIG. 5A is a perspective view of an output waveguide similar to the output waveguide of FIG. 2B for three-way combiner embodiments.

FIG. 5B is an S-parameters plot representing simulated performance of the output waveguide of FIG. 5A for three-way splitting or combining.

FIG. 5C is an S-parameters plot representing simulated responses of the three-way power-combining device with input and output waveguides structured as represented by FIG. 5A.

FIG. 5D represents simulated RF power sweeps for the overall three-way power-combining device.

FIG. 6A is a perspective view of an output waveguide similar to the output waveguide of FIG. 2B for eight-way combiner embodiments.

FIG. 6B is an S-parameters plot representing simulated performance of the output waveguide of FIG. 6A for eight-way splitting or combining.

FIG. 6C is an S-parameters plot representing simulated responses of the eight-way power-combining device with input and output waveguides structured as represented by FIG. 6A.

FIG. 6D represents simulated RF power sweeps for the eight-way power-combining device.

FIG. 7 is a generalized schematic diagram of a system for transmitting RF energy that includes multiple ones of the power-combining device of FIGS. 2A to 2E.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term "and/or" includes any and all combinations of one or more of the associated listed items.

It will be understood that when an element such as a layer, region, or substrate is referred to as being "on" or extending "onto" another element, it can be directly on or extend directly onto the other element or intervening elements may also be present. In contrast, when an element is referred to as being "directly on" or extending "directly onto" another element, there are no intervening elements present. Likewise, it will be understood that when an element such as a layer, region, or substrate is referred to as being "over" or extending "over" another element, it can be directly over or extend directly over the other element or intervening elements may also be present. In contrast, when an element is referred to as being "directly over" or extending "directly over" another element, there are no intervening elements present. It will also be understood that when an element is referred to as being "connected" or "coupled" to another element, it can be directly connected or coupled to the other element or intervening elements may be present. In contrast, when an element is referred to as being "directly connected" or "directly coupled" to another element, there are no intervening elements present.

Relative terms such as "below" or "above" or "upper" or "lower" or "horizontal" or "vertical" may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms "a," "an," and "the" are intended to include the plural forms as well, unless the context clearly indicates otherwise. It will be further understood that the terms "comprises," "comprising," "includes," and/or "including" when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Embodiments are described herein with reference to schematic illustrations of embodiments of the disclosure. As such, the actual dimensions of the layers and elements can be different, and variations from the shapes of the illustrations as a result, for example, of manufacturing techniques and/or tolerances, are expected. For example, a region illustrated or described as square or rectangular can have rounded or curved features, and regions shown as straight lines may have some irregularity. Thus, the regions illustrated in the figures are schematic and their shapes are not intended to illustrate the precise shape of a region of a device and are not intended to limit the scope of the disclosure. Additionally, sizes of structures or regions may be exaggerated relative to other structures or regions for illustrative purposes and, thus, are provided to illustrate the general structures of the present subject matter and may or may not be drawn to scale. Common elements between figures may be shown herein with common element numbers and may not be subsequently re-described.

The disclosure relates generally to power-combining devices and, more particularly, to power-combining devices with multiple spatial power-combining devices for increased output power and related systems and methods. Power-combining devices with multiple spatial power-combining devices provide multiple levels of signal splitting for amplification, followed by multiple levels of signal combining to provide an output signal with increased output power. Exemplary power-combining devices are capable of providing output powers in the kilowatt range. Spatial power-combining devices may be radially arranged about a support structure of the overall power-combining device to provide multiple levels of radially splitting and multiple levels of radial combining.

Aspects of the present disclosure are particularly adapted to power-combining devices and with multiple spatial power-combining devices that operate at various radio frequencies (RF) including microwave frequencies, such as, by way of a non-limiting example, energy between about 300 megahertz (MHz) (100 centimeters (cm) wavelength) and 300 gigahertz (GHz) (0.1 cm wavelength). Additionally, embodiments may comprise operating frequency ranges that extend above microwave frequencies. In some embodiments, by way of non-limiting examples, the operating frequency range includes an operating bandwidth of 4 GHz to 40 GHz, or 2 GHz to 18 GHz, or 2 GHz to 20 GHz, or 25 to 40 GHz, among others. Accordingly, aspects of the present disclosure are related to power-combining devices and related systems that transmit RF energy, including but not limited to commercial and defense communication systems, radar systems, electronic warfare systems, satellite communication systems, and various other communication systems.

A spatial power-combining device typically includes a plurality of amplifier assemblies, and each amplifier assembly typically forms an individual signal path that includes an amplifier connected to an input antenna structure and an output antenna structure. An input coaxial waveguide is configured to provide a signal concurrently to each input antenna structure, and an output coaxial waveguide is configured to concurrently combine amplified signals from each output antenna structure. The plurality of amplifier assemblies are typically arranged coaxially about a center axis. Accordingly, the spatial power-combining device is configured to split, amplify, and combine an electromagnetic signal.

In the following figures, the terms “input” and “output” are generally used to refer to various portions of power-combining devices and/or spatial power-combining devices, where the term “input” is used to describe elements that reside along portions of devices where signals may propagate before amplification and the term “output” is used to describe elements that reside along portions of devices where signals may propagate after amplification. In various embodiments as described herein, portions of power-combining devices and/or spatial power-combing devices may exhibit some levels of symmetry between “input” portions and “output” portions. In this regard, descriptions relative to “input” elements may also be applicable to corresponding “output” elements and vice versa. Accordingly, the terms “input” and “output” as used herein may also be replaced with the terms “first” and “second” without deviating from the principles disclosed.

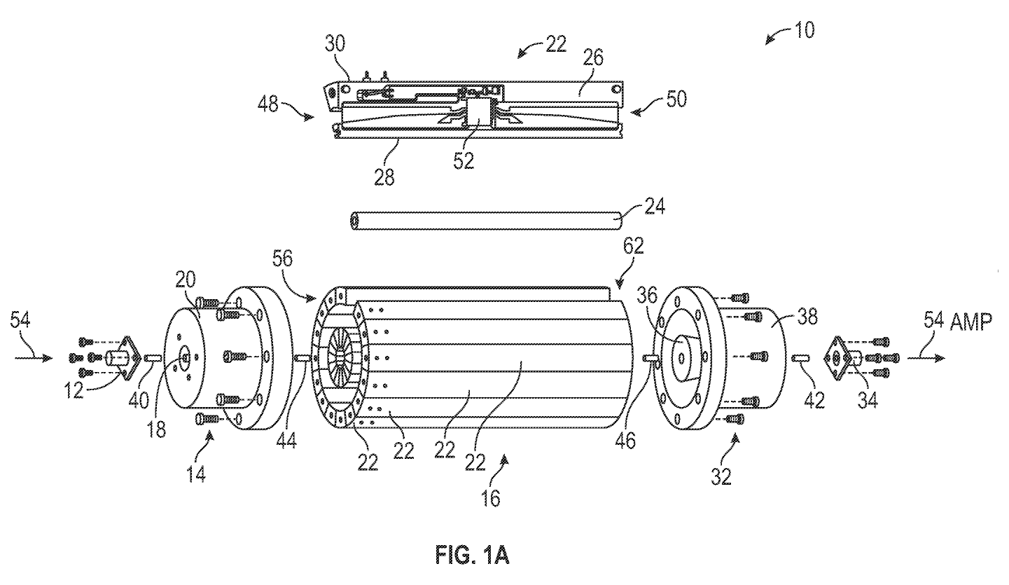

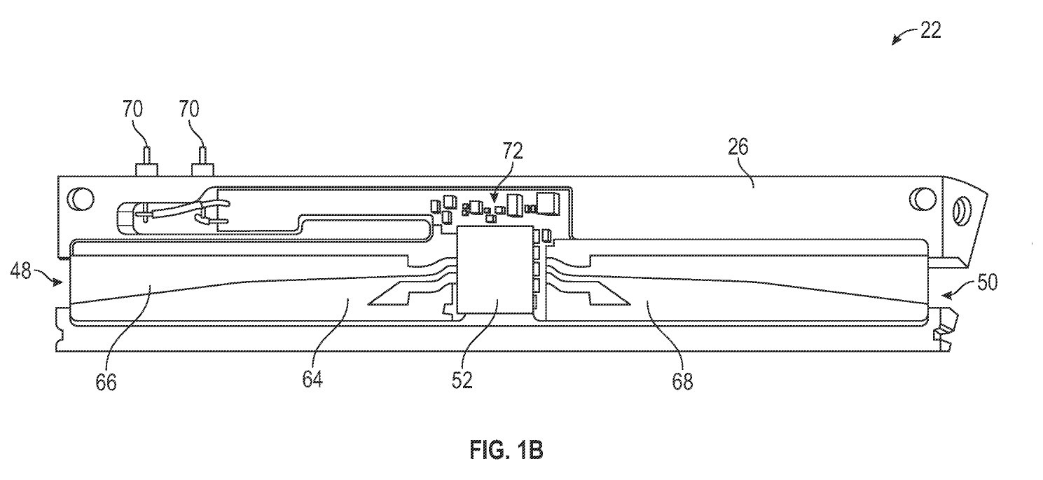

FIG. 1A is a partially-exploded perspective view of an exemplary spatial power-combining device 10. The spatial power-combining device 10 may comprise an input port 12 and an input coaxial waveguide section 14. The input coaxial waveguide section 14 provides a broadband transition from the input port 12 to a center waveguide section 16. Electrically, the input coaxial waveguide section 14 provides broadband impedance matching from an impedance Zₚ₁ of the input port 12 to an impedance Z_{c} of the center waveguide section 16. The input coaxial waveguide section 14 may include an inner conductor 18 and an outer conductor 20 that radially surrounds the inner conductor 18, thereby forming an opening therebetween. Outer surfaces of the inner conductor 18 and an inner surface of the outer conductor 20 may have gradually changed profiles configured to minimize the impedance mismatch from the input port 12 to the center waveguide section 16.

The center waveguide section 16 comprises a plurality of amplifier assemblies 22 arranged radially around a center axis of the spatial power-combining device 10. In certain embodiments, a center post 24 is provided at the center axis for mechanical support and the plurality of amplifier assemblies 22 may be positioned circumferentially around the center post 24. In other embodiments, the center post 24 may be omitted. In FIG. 1A, the center post 24 is illustrated in an exploded manner. Each amplifier assembly 22 may include a body structure 26 having a predetermined wedge-shaped cross-section, an inner surface 28, and an arcuate outer surface 30. When the amplifier assemblies 22 are collectively assembled radially about the center axis, they form the center waveguide section 16 with a generally cylindrical shape; however, other shapes are possible, such as rectangular, oval, or other geometric shapes.

The spatial power-combining device 10 may also comprise an output coaxial waveguide section 32 and an output port 34. The input port 12 and the output port 34 may comprise any of a field-replaceable Subminiature A (SMA) connector, a super SMA connector, a type N connector, a type K connector, 2.4 millimeter or 1 millimeter coaxial connectors for coverage up to 100 GHz, other coaxial to waveguide transition connectors, or any other suitable coaxial or waveguide connectors. In embodiments where the operating frequency range includes a frequency of at least 18 GHz, the output port 34 may comprise a waveguide output port, such as a WR28 or other sized waveguide.

The output coaxial waveguide section 32 provides a broadband transition from the center waveguide section 16 to the output port 34. Electrically, the output coaxial waveguide section 32 provides broadband impedance matching from the impedance Z_{c} of the center waveguide section 16 to an impedance Zₚ₂ of the output port 34. The output coaxial waveguide section 32 includes an inner conductor 36 and an outer conductor 38 that radially surrounds the inner conductor 36, thereby forming an opening therebetween. Outer surfaces of the inner conductor 36 and an inner surface of the outer conductor 38 may have gradually changed profiles configured to minimize the impedance mismatch from the output port 34 to the center waveguide section 16. In certain embodiments, a pin 40 connects between the input port 12 and the input coaxial waveguide section 14, and a pin 42 connects between the output port 34 and the output coaxial waveguide section 32. In certain embodiments, the center post 24 connects with the inner conductors 18, 36 by way of screws 44, 46 on opposite ends of the center post 24. The center post 24 is provided for simplifying mechanical connections, may have other than a cylindrical shape, or may be omitted altogether.

Each amplifier assembly 22 comprises an input antenna structure 48 and an output antenna structure 50, both of which are coupled to an amplifier 52. In certain embodiments, the amplifier 52 comprises a monolithic microwave integrated circuit (MMIC) amplifier. In further embodiments, the MMIC may be a solid-state gallium nitride (GaN)-based MMIC. A GaN MMIC device provides high power density and bandwidth, and a spatial power-combining device may combine power from a plurality of GaN MMICs efficiently in a single step to minimize combining loss.

In operation, an input signal 54 is propagated from the input port 12 to the input coaxial waveguide section 14, where it radiates between the inner conductor 18 and the outer conductor 20 and concurrently provides the input signal 54 to the center waveguide section 16. The input antenna structures 48 of the plurality of amplifier assemblies 22 collectively form an input antenna array 56. The input antenna array 56 couples the input signal 54 from the input coaxial waveguide section 14, distributing the input signal 54 substantially evenly to each one of the amplifier assemblies 22. Each input antenna structure 48 receives a signal portion of the input signal 54 and communicates the signal portion to the amplifier 52. The amplifier 52 amplifies the signal portion of the input signal 54 to generate an amplified signal portion that is then transmitted from the amplifier 52 to the output antenna structure 50. The output antenna structures 50 collectively form an output antenna array 62 that operates to provide the amplified signal portions to be concurrently combined inside the opening of the output coaxial waveguide section 32 to form an amplified output signal 54_{AMP}, which is then propagated through the output coaxial waveguide section 32 to the output port 34.

FIG. 1B is a perspective view of an individual amplifier assembly 22 of the spatial power-combining device 10 of FIG. 1A. The input antenna structure 48 may comprise an input signal conductor 64 supported on a first face of a substrate 66 or board, and the output antenna structure 50 comprises an output signal conductor 68 that is also supported on the first face of the substrate 66. The input signal conductor 64 and the output signal conductor 68 are electromagnetically coupled to the amplifier 52. The substrate 66 may comprise a printed circuit board that provides a desired form factor and mechanical support for the input signal conductor 64 and the output signal conductor 68. The input antenna structure 48 also includes an input ground conductor (not visible) on an opposing second face of the substrate 66 to the input signal conductor 64. In a similar manner, the output antenna structure 50 includes an output ground conductor (not visible) on the opposing second face of the substrate 66 to the output signal conductor 68. In other embodiments, the substrate 66 may be substituted with a plurality of substrates or boards. In still other embodiments, the input signal conductor 64, the input ground conductor (not visible), the output signal conductor 68, and the output ground conductor (not visible) are mechanically supported by the body structure 26 such that the substrate 66 may not be present. In certain embodiments, one or more ports 70 are provided for an external voltage input, such as from a direct current voltage source, and corresponding bias circuitry 72 is provided to control the amplifier 52. In certain embodiments, the bias circuitry 72 is arranged on the same substrate 66 as the antenna structures 48, 50. In other embodiments, a separate substrate may be provided for the bias circuitry 72.

In operation, a portion of the input signal (54 in FIG. 1A) is received by the input antenna structure 48 where it radiates between the input signal conductor 64 and the input ground conductor (not visible) and propagates to the amplifier 52 for amplification. For embodiments with a substrate 66, the portion of the input signal (54 in FIG. 1A) radiates between the input signal conductor 64 and the input ground conductor (not visible) through the substrate 66. For embodiments without a substrate 66, the portion of the input signal (54 in FIG. 1A) radiates between the input signal conductor 64 and the input ground conductor (not visible) through air. The amplifier 52 outputs a portion of the amplified signal (54_{AMP} in FIG. 1A) to the output antenna structure 50 where it radiates between the output signal conductor 68 and the output ground conductor (not visible) in a similar manner.

Turning back to FIG. 1A, the spatial power-combining device 10 is typically utilized for high power-combining applications. Accordingly, the amplifier 52 in each of the amplifier assemblies 22 is configured for high power amplification and may therefore generate a high amount of heat. If the operating temperature of each amplifier 52 increases too much, the performance and lifetime of each amplifier 52 may suffer. As previously described, the plurality of amplifier assemblies 22 forms the center waveguide section 16. In this regard, thermal management is needed to effectively dissipate heat in and around the center waveguide section 16. Accordingly, the body structure 26 of each amplifier assembly 22 may typically comprise a thermally conductive material, such as copper (Cu), aluminum (Al), or alloys thereof that are configured to dissipate enough heat from the amplifier 52 to maintain a suitably low operating temperature. In certain applications, the body structure 26 may comprise graphite with an electrically conductive film, such as nickel (Ni), Cu, or combinations thereof. In still further embodiments, the body structure may comprise metal-ceramic composites, including copper-diamond and/or aluminum-diamond.

In spatial power-combining devices, power splitting on the input side of the amplifier 52 and power combining on the output side of the amplifier 52 are accomplished using the same physics where quasi-transverse electromagnetic (TEM) fields are discretized in an over-moded coaxial structure by the use of the antenna structures 48, 50. As the TEM fields pass along the length of the antenna structures 48, 50, coaxial fields are thereby split and converted to either microstrip (uStrip) or coplanar waveguide (CPW) transmissions, thereby facilitating interfacing with the amplifier 52 (e.g., a MMIC) for amplification. In practice, all of the various elements along the RF chain must be sized inversely proportional to the frequency of operation. In this regard, physical limitations exist that can limit a number of amplifiers that may be provided with a single spatial power-combining device. By way of example, the center waveguide section 16 as illustrated in FIG. 1A includes sixteen amplifier assemblies 22. In order to increase a number of amplifiers assemblies 22 and corresponding amplifiers 52 present for a same targeted operating frequency, a width of the wedge shape for each body structure 26 as measured from the first face to the second face would need to be reduced. For example, to double the output power, the width of each body structure 26 would need to be reduced by half so that thirty-two amplifier assemblies 22 may fit together in a same radial footprint as the sixteen amplifier assemblies 22 illustrated in FIG. 1A. However, such reduced width may result in body structures 26 that are mechanically unstable, particularly for higher frequency applications associated with spatial power-combining devices. In this regard, physical limitations related to mechanical integrity of the body structure 26 can limit output powers in spatial power-combining devices, particularly for portions of the body structure 26 along or near the inner surface 28.

According to aspects of the present disclosure, output powers for power-combining devices are increased by splitting a signal to multiple spatial power-combining devices of a common device or system. Each additional spatial power-combining device corresponds with an additional and separate transmission path or chain for the overall power-combining device. The spatial power-combining device along each separate transmission path further splits the signal for amplification along the multiple amplifier assemblies associated with each spatial power-combining device. Such power-combining devices are capable of providing output powers in the kilowatt (kW) range. Various exemplary embodiments are described herein in the context of power-combining devices with four spatial power-combining devices; however, the principles described herein are readily scalable to any number of included spatial power-combining devices, such as at least two spatial power-combining devices and greater than four spatial power-combining devices.

Each individual spatial power-combining device provides high combining efficiency over large bandwidths to provide increased figure of merit power-combining performances. Moreover, each individual spatial power-combining device may exhibit increased reliability when employing GaN MMICs as amplifiers, while being compact, lightweight, and with reduced costs. By integrating multiple spatial power-combining in a single power-combining device, increased output powers, such as at least 1 kW, or at least 2 kW, and up to 5 kW or even 6 kW is achievable, depending on the number of integrated spatial power-combining devices. By way of example, a power-combining device with four spatial power-combining devices, each of which embodying a 16-way combiner with 16 radial amplifier assemblies, may provide an output power of about 2 kW. In another example, a power-combining device with eight spatial power-combining devices, each of which embodying a 16-way combiner with 16 radial amplifier assemblies, may provide an output power of about 4 kW. The overall power-combining device may provide rapid turn on, higher reliability, longer solid-state power amplifier lifetime, and with lower costs as compared with conventional traveling wave tube amplifiers while also being reusable and/or repairable.

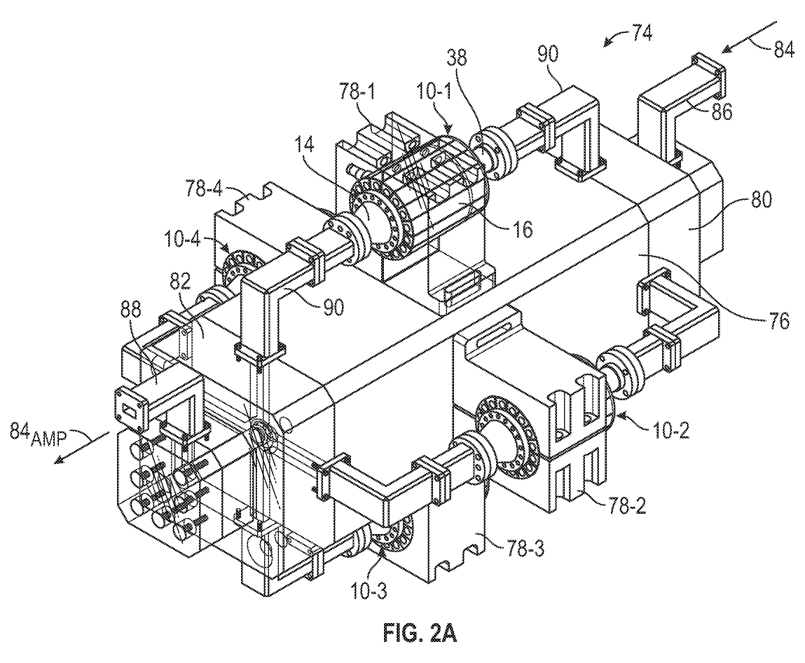

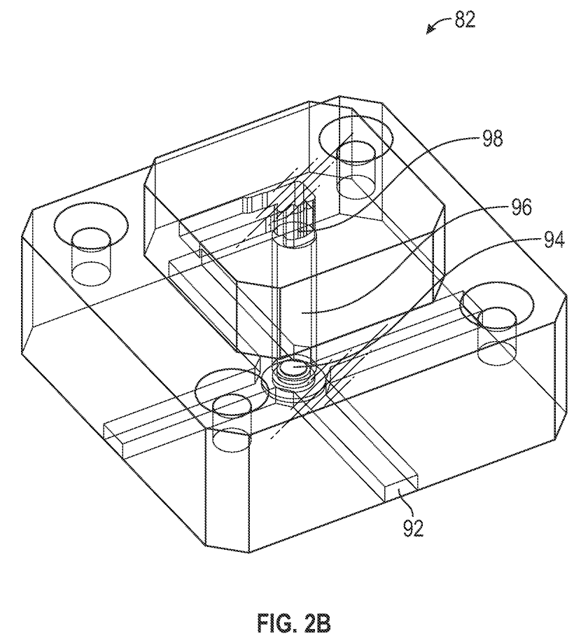

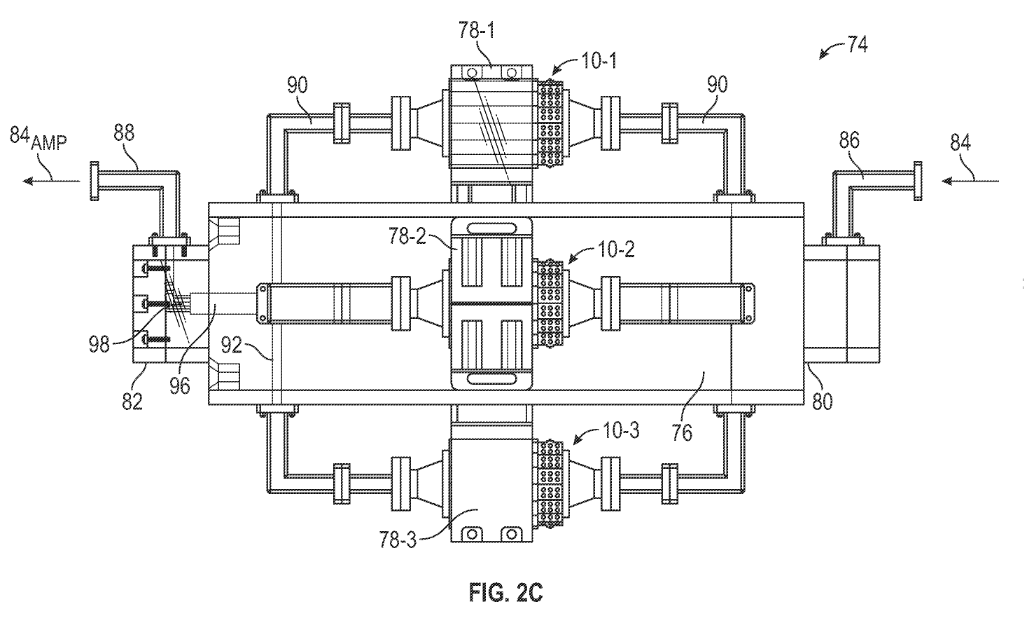

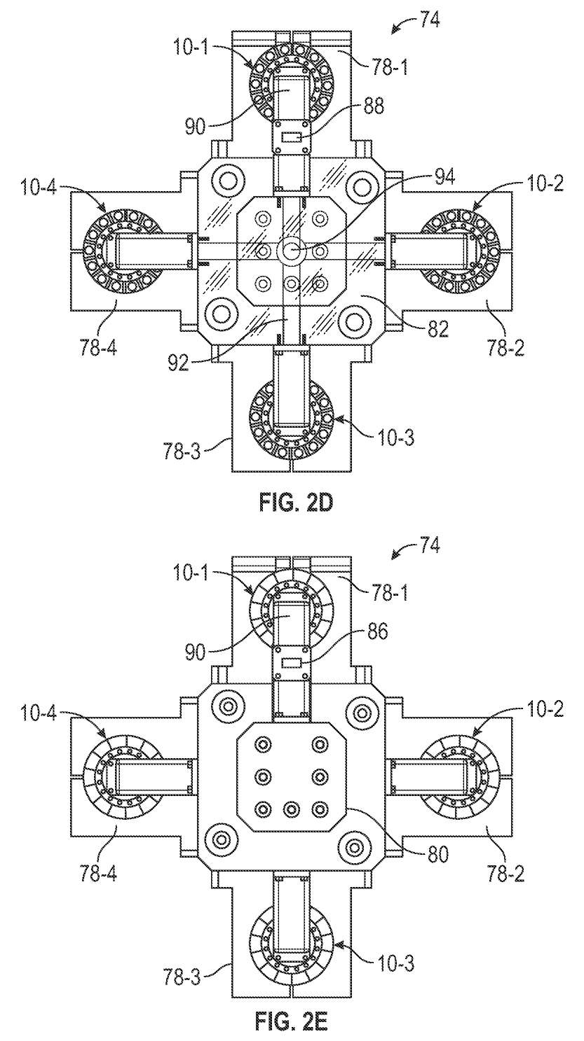

FIG. 2A is a perspective view of a power-combining device 74 with four spatial power-combining devices 10-1 to 10-4 arranged to receive split portions of an input signal for amplification. In certain embodiments, the spatial power-combining devices 10-1 to 10-4 of FIG. 2A may have a same or similar structure as the spatial power-combining device 10 of FIGS. 1A and 1B. In other embodiments, the number of amplifier assemblies (e.g., 22 of FIGS. 1A and 1B) per spatial power-combining device 10-1 to 10-4 may be any number, such as eight or sixteen in various examples.

In FIG. 2A, the spatial power-combining devices 10-1 to 10-4 are mounted to a support structure 76. The support structure 76 may comprise thermally conductive materials and/or structures to form a common heat sink for the spatial power-combining devices 10-1 to 10-4. In one example, the support structure 76 comprises a metal block, such as an aluminum block, for dissipating heat. In addition to passive heat dissipation, the support structure 76 may further comprise active cooling structures, such as liquid cooling channels, heat pipes and the like that are internal to the support structure 76. In certain embodiments, a first spatial power-combining device 10-1 is mounted to a first face of the support structure 76, and a second spatial power-combining device 10-2 is mounted to a second face of the support structure 76 that is different from the first face. In still further embodiments, each spatial power-combining device 10-1 to 10-4 is mounted to a different face of the support structure 76 to provide even heat dissipation. In the example of four spatial power-combining devices 10-1 to 10-4, the support structure 76 may form a block structure having a square or rectangular cross-section to form four mounting faces. For embodiments with additional numbers of spatial power-combining devices 10-1 to 10-4, the support structure 76 may have different shapes, such as a cross-section of an octagon to provide eight mounting faces for eight spatial power-combining devices. In still further embodiments, the support structure 76 may be formed with a suitable size such that multiple spatial power-combining devices 10-1 to 10-4 may be mounted on a same face. For example, a four-sided support structure 76 may be suitably sized to accommodate eight spatial power-combining devices with two spatial power-combining devices per face.

In certain embodiments, each spatial power-combining device 10-1 to 10-4 may be attached and thermally connected to an individual heat sink 78-1 to 78-4 for additional thermal dissipation. For illustrative purposes, the individual heat sink 78-1 is illustrated as transparent to better illustrate how each spatial power-combining device 10-1 to 10-4 may be at least partially enclosed by the respective heat sink 78-1 to 78-4. In one example, each heat sink 78-1 to 78-4 embodies at least a two-part structure that is arranged to sandwich a portion of the corresponding spatial power-combining device 10-1 to 10-4, such as portions of each center waveguide section 16 of FIG. 1A. As further illustrated in FIG. 2A, each heat sink 78-1 to 78-4 may be mechanically and thermally coupled to the support structure 76 such that at least some heat propagating within heat sinks 78-1 to 78-4 may be transferred to the support structure 76. By way of example, each heat sink 78-1 to 78-4 may be bolted to the support structure 76.

The power-combining device 74 includes an input waveguide 80 and an output waveguide 82. The input waveguide 80 is configured to split an input signal 84 received by an input port 86 of the power-combining device 74 into a number of split portions that are directed to each spatial power-combining device 10-1 to 10-4 for amplification. Outputs of each spatial power-combining device 10-1 to 10-4 are then combined by the output waveguide 82 to provide an amplified output signal 84_{AMP} from an output port 88 of the power-combining device 74. For illustrative purposes, the output waveguide 82 is illustrated as transparent to show internal waveguide channels for combining signals from each of the spatial power-combining devices 10-1 to 10-4. It is appreciated that the internal structure of the input waveguide 80 may mirror the structure of the output waveguide 82. In certain embodiments, the input port 86, the input waveguide 80, the output waveguide 82, and the output port 88 comprise rectangular waveguide channels. For example, the input port 86 may form a rectangular waveguide that feeds the input signal 84 to the input waveguide 80 for splitting, and the output port 88 may also form a rectangular waveguide for the amplified output signal 84_{AMP}. The input waveguide 80 and the output waveguide 82 may be configured to efficiently transition RF energy between multiple waveguide modes. Various other waveguides 90, such as rectangular waveguides, may be employed to couple signals from the input waveguide 80 to respective spatial power-combining devices 10-1 to 10-4, and then to the output waveguide 82.

FIG. 2B is a perspective view of the output waveguide 82 of FIG. 2A. In a similar manner as depicted by FIG. 2A, the output waveguide 82 of FIG. 2B is depicted as transparent for illustrative purposes. The output waveguide 82 is configured for combining N-way transverse electric (TE₁₀) modes (four in this example) received from the rectangular waveguides along internal waveguide channels 92. The internal waveguide channels 92 may form rectangular waveguide channels in certain embodiments. The N-way TE₁₀ modes are combined to a transverse magnetic (TM₀₁) mode by a first mode converter 94 at a junction between the waveguide channels 92. The first mode converter 94 may embody a stepped or tapered pedestal that combines to a common cylindrical waveguide channel 96. The TM₀₁ mode may be converted back to the TE₁₀ mode via a second mode converter 98 at an end of the cylindrical waveguide channel 96. In certain embodiments, the second mode converter 98 embodies two coupling holes on the top or end of the cylindrical waveguide channel 96. Relative sizes of the first and second mode converters 94, 98 provide a key design factor for providing the optimal RF performance in the radial combiner function for the output waveguide 82, which may depend on various applications, such as a number of combining signals and/or a waveguide size per desired operating frequency. By way of example, portions of the output waveguide 82 may embody a WR62 rectangular waveguide for a frequency from 13 GHz to 16 GHz for a sixteen amplifier configuration of each spatial power-combining device. In other examples, designs for all waveguide sizes from microwave to mmWave frequencies, such as from WR340 waveguides for 2 GHz operation to WR1 waveguides for 1,100 GHz operation. While FIG. 2B is provided from the perspective of the output waveguide 82, the principles described are applicable to the structure of the input waveguide 80 of FIG. 2A with a reverse signal propagation direction.

FIG. 2C is a side view of the power-combining device 74 of FIG. 2A. As with FIGS. 2A and 2B, the output waveguide 82 is depicted in transparent for illustrative purposes. The waveguide channels 92 interior to the output waveguide 82 receive amplified signals from each spatial power-combining device 10-1 to 10-4. As described above with respect to FIG. 2B, the waveguide channels 92 converge to the cylindrical waveguide channel 96 before passing through the second mode converter 98 and out of the output port 88.

FIG. 2D is an end view of the power-combining device 74 of FIG. 2A from the perspective of the output waveguide 82. FIG. 2E is an opposing end view of the power-combining device 74 of FIG. 2A from the perspective of the input waveguide 80. As illustrated, each spatial power-combining device 10-1 to 10-4 is radially arranged relative to each other about the support structure 76 visible in FIG. 2A. In this manner, the power-combining device 74 may form a larger spatial power-combining device formed by multiple individual spatial power-combining devices 10-1 to 10-4. Accordingly, the input signal is first split before by the input waveguide 80 and each portion is then split again for amplification at each individual spatial power-combining device 10-1 to 10-4. On the output side, the amplified signals are first combined within each individual spatial power-combining device 10-1 to 10-4 and further combined at the output waveguide 82. Moreover, heat generated by each spatial power-combining device 10-1 to 10-4 may be more readily dissipated by way of the radial arrangement.

With reference to FIGS. 2A to 2E, the power-combining device 74 according to the present disclosure may be formed by radially arranging the plurality of spatial power-combining devices 10-1 to 10-4 about the support structure 76. The method for forming the power-combining device 74 further includes coupling the input waveguide 80 to the plurality of spatial power-combining devices 10-1 to 10-4, wherein the input waveguide 80 is configured to split the input signal 84, and coupling the output waveguide 82 to the plurality of spatial power-combining devices 10-1 to 10-4, wherein the output waveguide 82 is configured to combine amplified signals from the plurality of spatial power-combining devices 10-1 to 10-4 into an output signal 84_{AMP}. As indicated above, the method may further comprise thermally coupling the plurality of individual heat sinks 78-1 to 78-4 to the support structure 76, wherein each individual heat sink of the plurality of individual heat sinks 78-1 to 78-4 is arranged to at least partially enclose a portion of a separate or corresponding spatial power-combining device of the plurality of spatial power-combining devices 10-1 to 10-4. In various implementations, the input signal 84 is split into at least two split signals by the input waveguide 80 based on the number of spatial power-combining devices 10-1 to 10-4. Each spatial power-combining device 10-1 to 10-4 is then configured to further split each split signal a number of times based on how many amplifier assemblies (e.g., 22 of FIG. 1A) are included with each spatial power-combining device 10-1 to 10-4. Each spatial power-combining device 10-1 to 10-4 is configured to recombine and output amplified signals to the output waveguide 82, which in turn recombines the received signals into the output signal 84_{AMP}. By way of example, the input waveguide 80 and the output waveguide 82 may form four-way splitters/combiners, and each spatial power-combining device 10-1 to 10-4 may further split and combine signals at least eight times or at least sixteen times depending on the embodiment. In certain embodiments, the spatial power-combining devices 10-1 to 10-4 are radially arranged about the support structure 76 of the overall power-combining device 74 to provide multiple levels of radially splitting and multiple levels of radial combining.

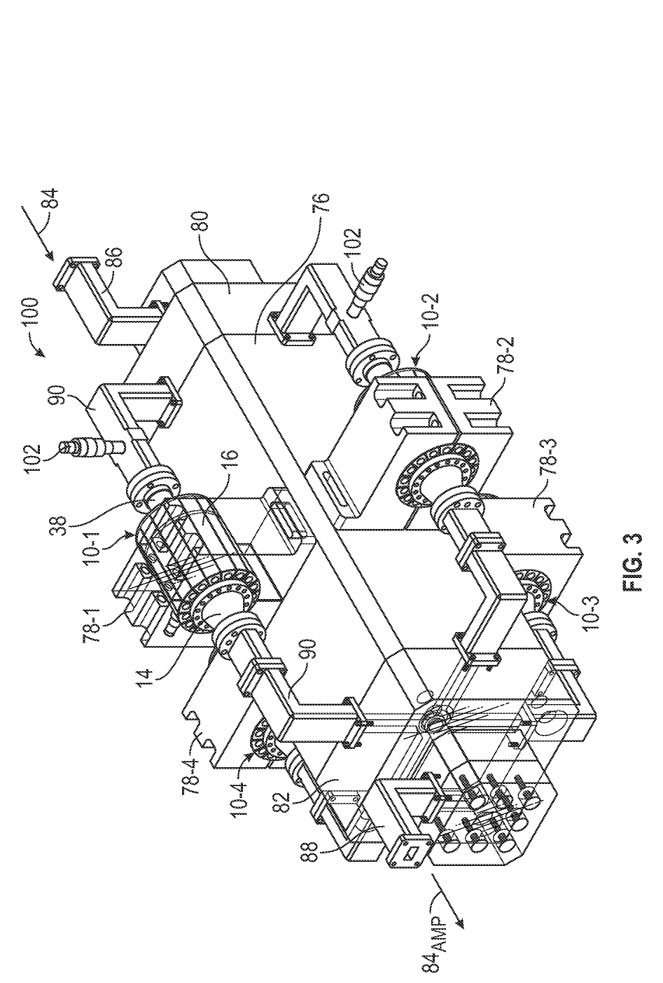

FIG. 3 is a perspective view of a power-combining device 100 that is similar to the power-combining device 74 of FIGS. 2A to 2E for embodiments that further include one or more phase shifters 102. In various implementations, it may be necessary to tune phases of split input signals to match to reduce volatility and increase output power. In certain embodiments, one or more of the phase shifters 102 may be positioned between the input waveguide 80 and one or more of the spatial power-combining devices 10-1 to 10-4. By way of example, the phase shifters 102 may be positioned on one or more or even all of the waveguides 90 connecting between the input waveguide 80 and the spatial power-combining devices 10-1 to 10-4. Accordingly, the phase of the respective split input signals may be matched by tuning one or more of the phase shifters 102 before amplification in the spatial power-combining devices 10-1 to 10-4. In certain embodiments, the phase shifters 102 may comprise mechanical phase shifters, such as a micrometer, and/or digital phase shifters. For embodiments with multiple phase shifters 102, each phase shifter 102 may be configured to be independently adjustable. In certain embodiments, multiple phase shifters 102 may be configured for common control by way of a common digital shifter, or the like.

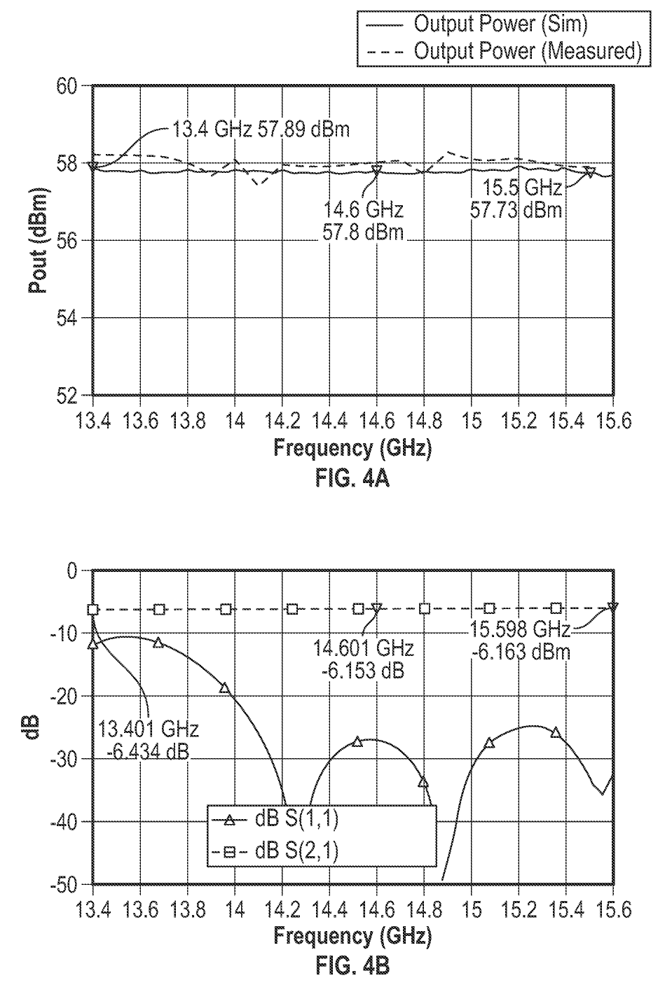

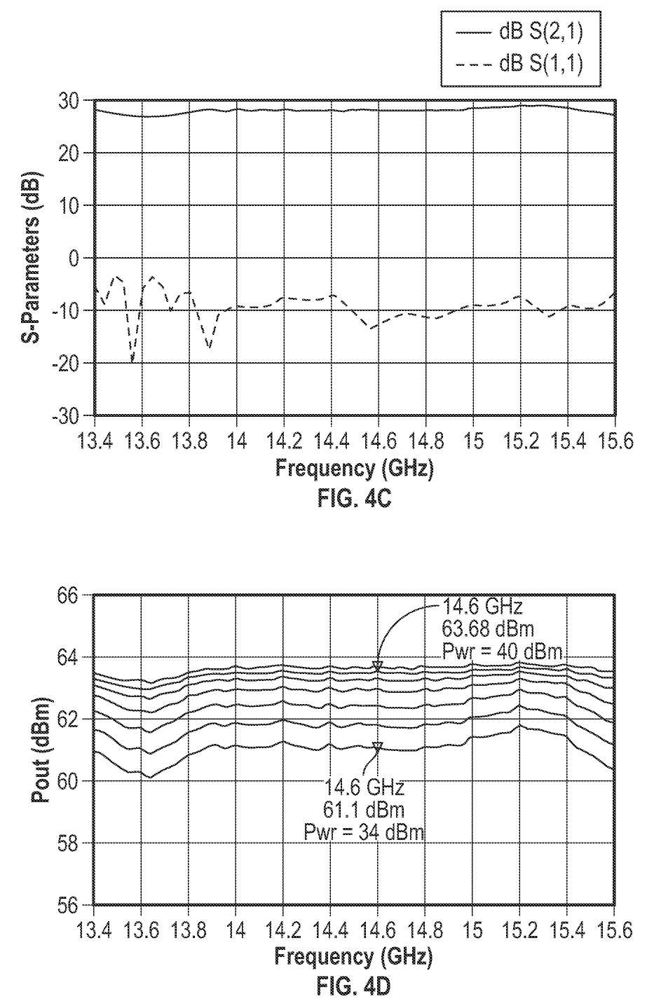

FIGS. 4A to 4D represent various plots demonstrating performance simulations for the power-combing device 74 of FIGS. 2A to 2E. The specific arrangement for the power-combing device 74 and integrated spatial power-combining devices 10-1 to 10-4 of FIGS. 2A to 2E was selected as four total spatial power-combining devices 10-1 to 10-4, each of which is structured with 16 amplifier assemblies 22 of FIG. 1B. For the purpose of the simulations, the amplifier, or MMIC, for each spatial power-combining device 10-1 to 10-4 was selected as a 13-15.9 GHz 80W GaN power amplifier module, described in the Qorvo data sheet titled “QPM2239” revision D. Such an amplifier module is specifically designed for Ku-band operation. However, the frequency may be designed for any band of interest, such as C-band, X-band, Ka-band, Q-band, V-band, E-band, and W-band without deviating from the principles described.

FIG. 4A is a plot representing output power versus frequency for each individual spatial power-combining device 10-1 to 10-4 of FIG. 2A. For an input power of 34 decibel-milliwatts (dBm), the output power for each spatial power-combining device 10-1 to 10-4 is above 57 dBm in both the simulation and the actual measurements.

FIG. 4B is an S-parameters plot representing simulated performance of the input or output waveguides 80 or 82 of FIGS. 2A to 2E for four-way splitting or combining. In FIG. 4B, S(2,1) is an indication of how much power is transferred. For frequencies where S(2,1) is equal to 0 decibels (dB), then substantially all power from a signal is transferred. As illustrated, the simulation demonstrates good power transfer with losses of about 6.2 to 6.4 dB over a frequency range of 13.4 GHz to 15.6 GHz.

FIG. 4C is an S-parameters plot representing simulated responses of the overall power-combining device of FIGS. 2A to 2E. As illustrated, the small signal gain response, or S(2,1), is predicted to be greater than 25 dB over the frequency range.

FIG. 4D represents simulated RF power sweeps for the overall power-combining device of FIGS. 2A to 2E. The non-linear power sweep ranges from input powers of 34 dBm to 40 dBm. As illustrated, output power is predicted to be about 63.68 dBm with 40 dBm input power, or about 2,290 watts.

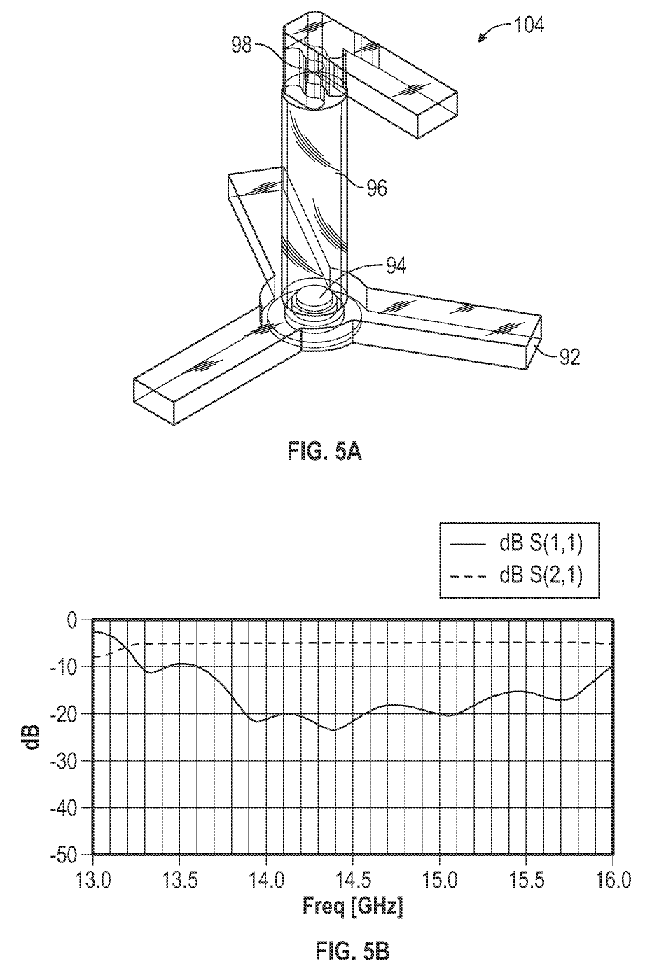

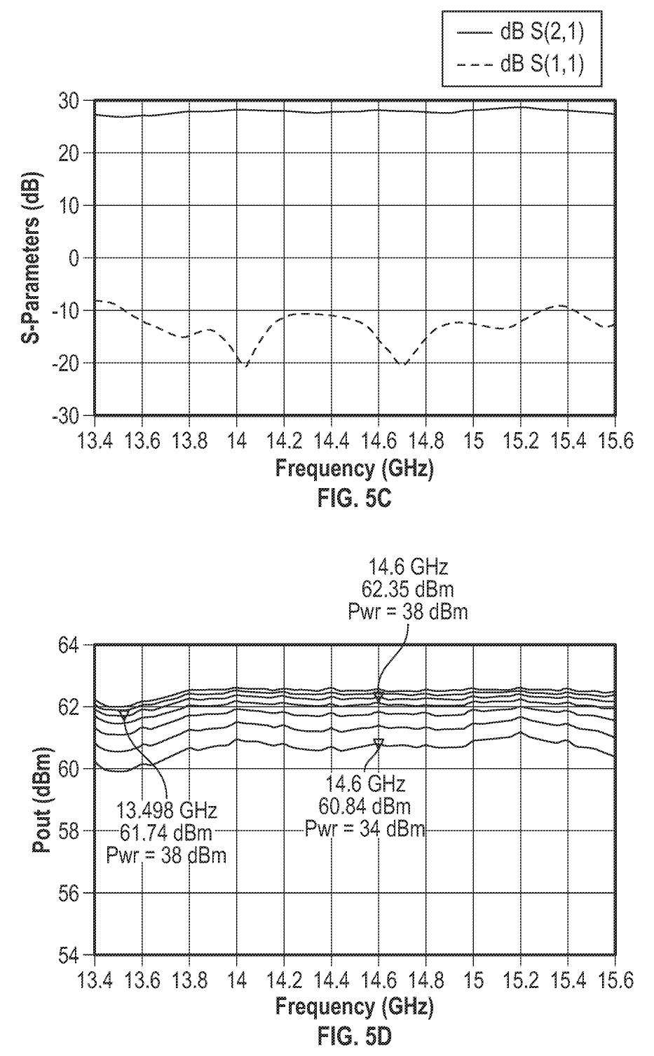

FIGS. 5A and 5D represent structures and plots demonstrating performance simulations for a power-combining device similar to the power-combing device 74 of FIGS. 2A to 2E, but with three spatial power-combining devices similar to FIGS. 1A and 1B.

FIG. 5A is a perspective view of an output waveguide 104 similar to the output waveguide 82 of FIG. 2B for three-way combiner embodiments. In this manner, three waveguide channels 92 combine at the first mode converter 94 at one end of the cylindrical waveguide channel 96. The second mode converter 98 is positioned at an opposite end of the cylindrical waveguide channel 96 in a manner similar to FIG. 2A. For illustrative purposes, only waveguide propagation pathways are illustrated. As with previous embodiments, the structure and performance of the output waveguide 104 may also represent an input waveguide for a three-way power-combining device in an input signal direction.

FIG. 5B is an S-parameters plot representing simulated performance of the output waveguide 104 of FIG. 5A for three-way splitting or combining. As illustrated, the simulation demonstrates good power transfer over a frequency range of 13.0 GHz to 16.0 GHz.

FIG. 5C is an S-parameters plot representing simulated responses of the three-way power-combining device with input and output waveguides structured as represented by FIG. 5A. As illustrated, the small signal gain response, or S(2,1), is predicted to be greater than 25 dB over the same frequency range as illustrated by FIG. 5C.

FIG. 5D represents simulated RF power sweeps for the overall three-way power-combining device. The non-linear power sweep ranges begin at input powers of 34 dBm. As illustrated, output power is predicted to be about 62.35 dBm with 38 dBm input power, or about 1,300 watts.

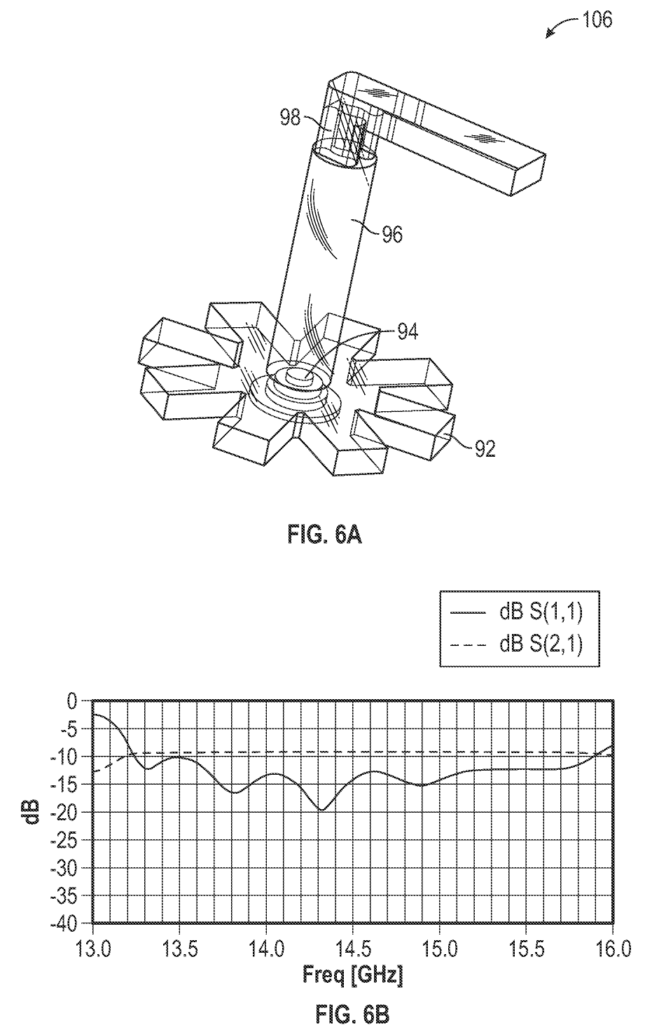

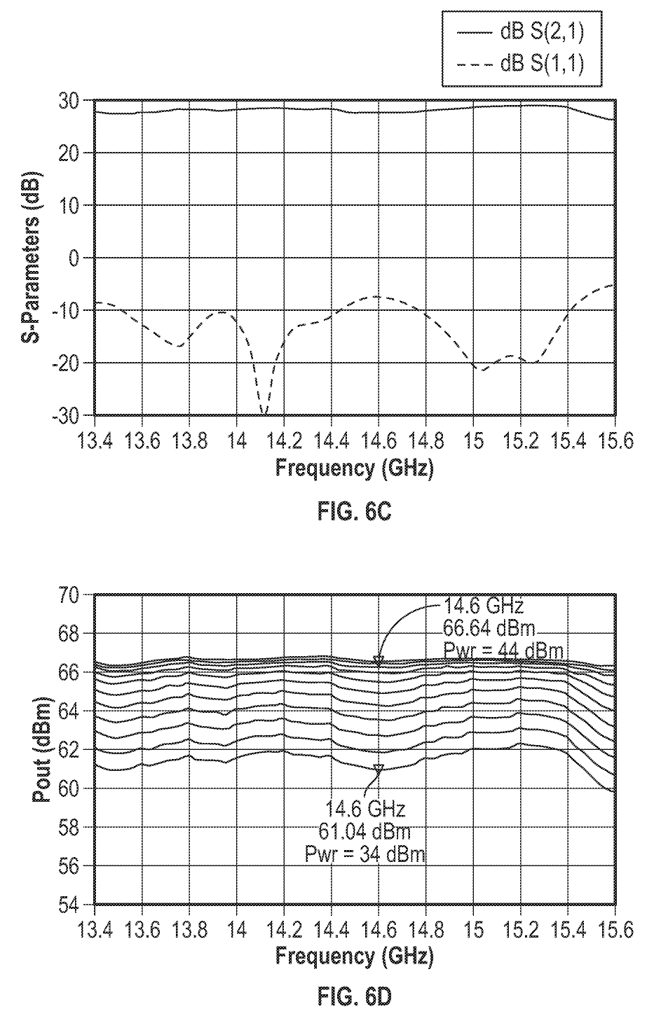

FIGS. 6A and 6D represent structures and plots demonstrating performance simulations for a power-combining device similar to the power-combing device 74 of FIGS. 2A to 2E, but with eight spatial power-combining devices similar to FIGS. 1A and 1B.

FIG. 6A is a perspective view of an output waveguide 106 similar to the output waveguide 82 of FIG. 2B for eight-way combiner embodiments. In this manner, eight waveguide channels 92 combine at the first mode converter 94 at one end of the cylindrical waveguide channel 96. The second mode converter 98 is positioned at an opposite end of the cylindrical waveguide channel 96 in a manner similar to FIG. 2A. For illustrative purposes, only waveguide propagation pathways are illustrated. As with previous embodiments, the structure and performance of the output waveguide 106 may also represent an input waveguide for an eight-way power-combining device in an input signal direction.

FIG. 6B is an S-parameters plot representing simulated performance of the output waveguide 106 of FIG. 6A for eight-way splitting or combining. As illustrated, the simulation demonstrates good power transfer over a frequency range of 13.0 GHz to 16.0 GHz.

FIG. 6C is an S-parameters plot representing simulated responses of the eight-way power-combining device with input and output waveguides structured as represented by FIG. 6A. As illustrated, the small signal gain response, or S(2,1), is predicted to be greater than 25 dB over the frequency range.

FIG. 6D represents simulated RF power sweeps for the eight-way power-combining device. The non-linear power sweep ranges from input powers of 34 dBm to 44 dBm. As illustrated, output power is predicted to be about 66.66 dBm with 44 dBm input power, or about 4,570 watts.

In view of FIGS. 4A to 6D, a combined N-way power-combining device with GaN MMICs integrated as amplifiers for each spatial power-combining device may produce RF output powers in the kilowatt range. The presented simulations represent radial power-combiners that are four-way (FIGS. 4A to 4D), eight-way (FIGS. 5A to 5D), or three-way (FIGS. 6A to 6D). However, the principles disclosed are readily applicable to various other N-way numbers. This high-power N-way power-combining device provides increased output powers that would be useful for current and future RF amplifier applications. By integrating multiple spatial power-combining devices in a single power-combining device, increased output powers, such as at least 1 kW or at least 2 kW and up to 5 kW or even 6 kW, are achievable for use in earth and/or space applications. In certain applications, multiple ones of the power-combining devices described herein may further be combined as part of a larger system for transmitting RF energy, such as for high power communications, radar, electronic warfare, particle accelerators, and the like.

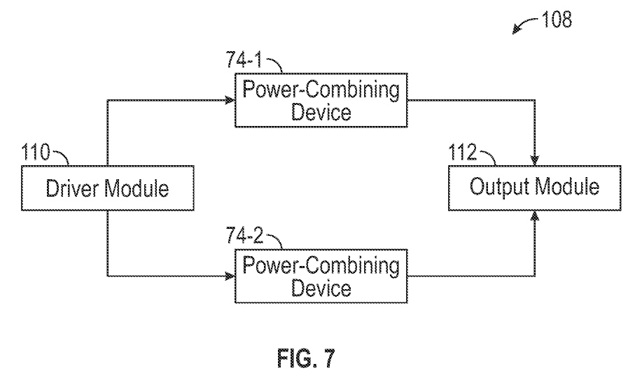

FIG. 7 is a generalized schematic diagram of a system 108 for transmitting RF energy that includes multiple power-combining devices 74-1, 74-2 of FIGS. 2A to 2E. Each power-combining device 74-1, 74-2 may embody an N-way combiner as described above with respect to any embodiments of FIGS. 1A to 6D, such as three-way combiners, four-way combiners, and/or eight-way combiners. Moreover, the power-combining device 74-1, 74-2 may further include the one or more phase shifters 102 as described above with respect to FIG. 3. While two power-combining devices 74-1, 74-2 are illustrated, the system 108 may be readily scalable to any number of power-combining devices 74-1, 74-2. The system 108 may include a driver module 110 configured to drive and/or provide an input signal to each power-combining device 74-1, 74-2. In certain embodiments, the driver module 110 may even include a spatial power-combining device similar to the spatial power-combining device 10 of FIGS. 1A to 1B. After amplification with each power-combining device 74-1, 74-2, amplified output signals may be combined and fed to an output module 112, such as an antenna, a focused antenna, or other high power output structures. In practice, the system 108 may embody commercial or defense communication systems, radar systems, electronic warfare systems, satellite communication systems, particle accelerators, and various other communication systems.

It is contemplated that any of the foregoing aspects, and/or various separate aspects and features as described herein, may be combined for additional advantage. Any of the various embodiments as disclosed herein may be combined with one or more other disclosed embodiments unless indicated to the contrary herein.

Those skilled in the art will recognize improvements and modifications to the preferred embodiments of the present disclosure. All such improvements and modifications are considered within the scope of the concepts disclosed herein and the claims that follow.

What is claimed is:

1. A power-combining device comprising:
an input waveguide configured to split an input signal;
a plurality of spatial power-combining devices coupled with the input waveguide, each spatial power-combining device of the plurality of spatial power-combining devices configured to receive a split portion of the input signal; and
an output waveguide configured to combine amplified signals from the plurality of spatial power-combining devices into an output signal.

2. The power-combining device of claim 1, further comprising a support structure, wherein the plurality of spatial power-combining devices are mounted to the support structure.

3. The power-combining device of claim 2, wherein a first spatial power-combining device of the plurality of spatial power-combining devices is mounted to a first face of the support structure, and a second spatial power-combining device of the plurality of spatial power-combining devices is mounted to a second face of the support structure, and the second face is different than the first face.

4. The power-combining device of claim 2, wherein each individual spatial power-combining device of the plurality of spatial power-combining devices is mounted on a different face of the support structure.

5. The power-combining device of claim 2, wherein the support structure forms a common heat sink for the plurality of spatial power-combining devices.

6. The power-combining device of claim 5, further comprising a plurality of individual heat sinks coupled to the common heat sink, wherein each individual heat sink of the plurality of individual heat sinks is arranged to at least partially enclose a portion of a separate spatial power-combining device of the plurality of spatial power-combining devices.

7. The power-combining device of claim 1, wherein the input waveguide and the output waveguide each comprise at least two mode converters for transitioning between multiple waveguide modes.

8. The power-combining device of claim 7, wherein the input waveguide and the output waveguide each comprise a plurality of waveguide channels connected to a common waveguide channel at one of the at least two mode converters.

9. The power-combining device of claim 8, wherein the plurality of waveguide channels comprises rectangular waveguide channels and the common waveguide channel comprises a cylindrical waveguide channel.

10. The power-combining device of claim 1, further comprising at least one phase shifter positioned between the input waveguide and the plurality of spatial power-combining devices.

11. The power-combining device of claim 10, wherein the at least one phase shifter comprises a plurality of phase shifters, and each phase shifter of the plurality of phase shifters is configured to be independently adjustable.

12. The power-combining device of claim 10, wherein the at least one phase shifter comprises a plurality of phase shifters, and each phase shifter of the plurality of phase shifters is configured to be controlled for common control.

13. A system for transmitting radio frequency energy, the system comprising:
at least one power-combining device, wherein the at least one power-combining device comprises:
an input waveguide configured to split an input signal;
a plurality of spatial power-combining devices coupled with the input waveguide, each spatial power-combining device of the plurality of spatial power-combining devices configured to receive a split portion of the input signal; and
an output waveguide configured to combine amplified signals from the plurality of spatial power-combining devices into an output signal.

14. The system of claim 13, wherein the at least one power-combining device comprises a support structure, and the plurality of spatial power-combining devices are mounted to the support structure.

15. The system of claim 13, wherein the input waveguide and the output waveguide each comprise a plurality of waveguide channels connected to a common waveguide channel at one of at least two mode converters.

16. The system of claim 13, wherein the at least one power-combining device comprises a plurality of power-combining devices.

17. The system of claim 16, wherein the system comprises a driver module connected to the plurality of power-combining devices and an output module configured to receive the output signal.

18. A method of forming a power-combining device, the method comprising:
radially arranging a plurality of spatial power-combining devices about a support structure;
coupling an input waveguide to the plurality of spatial power-combining devices, the input waveguide configured to split an input signal; and
coupling an output waveguide to the plurality of spatial power-combining devices, the output waveguide configured to combine amplified signals from the plurality of spatial power-combining devices into an output signal.

19. The method of claim 18, further comprising thermally coupling a plurality of individual heat sinks to the support structure, wherein each individual heat sink of the plurality of individual heat sinks is arranged to at least partially enclose a portion of a separate spatial power-combining device of the plurality of spatial power-combining devices.

20. The method of claim 18, wherein the input waveguide is configured to split the input signal into at least two split signals, and each spatial power-combining device is configured to further split each split signal at least eight times for amplification.
